(19) United States
(12) Patent Application Publication
(10) Pub. No.: US 2017/0083953 A1
(43) Pub. Date: Mar. 23, 2017

(54) TRANSACTION BASED CHECK-IN TO RECOMMENDATION PROVIDING SOCIAL MEDIA PLATFORMS

(71) Applicant: MasterCard International Incorporated, Purchase, NY (US)

(72) Inventor: Ankur ARORA, Jasola (IN)

(73) Assignee: MasterCard International Incorporated, Purchase, NY (US)

(21) Appl. No.: 15/248,515

(22) Filed: Aug. 26, 2016

(30) Foreign Application Priority Data
Sep. 18, 2015 (SG) 10201507795S

(51) Int. Cl. G06Q 30/02; G06Q 20/20; G06Q 20/10; H04W 4/02; G06Q 20/32

(52) U.S. Cl. CPC G06Q 30/0282; H04W 4/02; G06Q 20/3278; G06Q 20/102; G06Q 20/204; G06Q 20/325; G06Q 50/01

(57) ABSTRACT

A method and system for providing location-based user-personalized recommendations for goods, services and activities to a user of a mobile communication device using a recommendation-providing social media platform is provided. The method includes automatically checking in to the merchant location on the recommendation-providing social media platform in response to settling the transaction at the merchant and automatically checking in to a predefined area which includes the merchant location. Then, the method includes identifying ones of the other merchants at the other merchant locations for recommending to the user in response to user historic transaction data and presenting the user through the recommendation-providing social media platform with merchant information for the identified ones of the other merchants in the predefined area, the merchant information including a merchant location corresponding to each of the identified ones of the other merchants in the predefined area.

### TECHNICAL FIELD

The present invention generally relates to methods and systems for an improved social media platform experience, and more particularly relates to methods and systems for pushing personalized merchant offers and recommendations to a user through a social media platform in response to settling a transaction at a point-of-sale (POS) device.

### BACKGROUND OF THE DISCLOSURE

Social media is not limited to the home computer. In today's world, mobile devices allow social media platforms to travel with the user throughout the day. Some social media platforms provide location-based recommendations to users for goods, services and activities such as recommendations for restaurants, nightlife spots, shops and other places of interest in response to the user indicating his/her location by, for example, a “check-in” to the social media platform. For example, Foursquare™ is a social media platform that displays recommendations based on the time of day such as displaying breakfast restaurants in the morning and dinner restaurants in the evening. Recommendations may be personalized by the Foursquare™ software based on factors that include a user's check-in history, their preferences inputted into the program and their prior venue ratings made through the program. Yet, in order to provide an improved location-based recommendation system, it is preferable to personalize the recommendations. Presently, such recommendations are dependent upon a user checking-in to locations through the program and the problem associated with check-ins via social media platforms is that recommendations provided by these applications are based only on the check-in history and do not have other history associated with the user, such as history of past purchases by the user.

Thus, what is needed is a method and system for presenting location-based recommendations to a user that are personalized for the user and which at least partially overcome present drawbacks. Furthermore, other desirable features and characteristics will become apparent from the subsequent detailed description and the appended claims, taken in conjunction with the accompanying drawings and this background of the disclosure.

### SUMMARY

According to at least one embodiment of the present invention a method for providing location-based user-personalized recommendations for goods, services and activities to a user of a mobile communication device having application software capable of accessing a recommendation-providing social media platform loaded thereon is provided. The method includes the user settling a transaction at a merchant having a merchant location. The method then includes automatically checking-in the user to the merchant location on the recommendation-providing social media platform in response to settling the transaction at the merchant and automatically checking-in the user to a predefined area which includes the merchant location on the recommendation-providing social media platform. The method further includes identifying ones of other merchants at other merchant locations within the predefined area for recommending to the user in response to user historic transaction data.

In accordance with another aspect of at least one embodiment of the present invention, a method in a server which provides a payment gateway for settling transactions is provided, the server comprising storage means for storing historic transactions of a user. The method includes receiving transaction data for settling a transaction between the user and a merchant having a merchant location within a predefined area and identifying ones of other merchants at other merchant locations within the same predefined area for recommending to the user in response to user preferences determined from the historic transaction data of the user. The method also includes providing information on the identified ones of the other merchants within the predefined area to a mobile communication device of the user for presentation to the user through application software on the mobile communication device.

In accordance with yet another aspect of at least one embodiment of the present invention, a mobile device including a processor, a transceiver, a user interface and a memory is provided. The transceiver is coupled to the processor for communicating with a payment gateway and for communicating with a server hosting a recommendation-providing social media platform including merchant information for a plurality of merchants within a predefined area. The user interface is coupled to the processor and includes a user input device for receiving user inputs and a user output device for presenting information to a user including visually displayed information. The memory is coupled to the processor and stores application software for coupling to the recommendation-providing social media platform at the server and the payment gateway when the application software is loaded to the processor for interaction by the user with the recommendation-providing social media platform via the user interface and for requesting and receiving information from the payment gateway. In response to the user settling a transaction at a merchant having a merchant location within a predefined area, the processor provides a present location of the wireless communication device to the recommendation-providing social media platform so that the recommendation-providing social media platform can automatically check the user in to the merchant and automatically check the user in to the predefined area on the recommendation-providing social media platform and the user interface presents the user through the application software merchant information for identified ones of other merchants in the predefined area, the identified ones of the other merchants in the predefined area identified by information forwarded from the payment gateway identifying the identified ones of the other merchants in the predefined area in response to historic transaction data of the user.

In accordance with a further aspect of at least one embodiment of the present invention, a system for providing location-based user-personalized recommendations for goods, services and activities is provided which includes a payment gateway, a server hosting a recommendation-providing social media platform and a mobile communication device of the user having application software stored thereon for coupling to the recommendation-providing social media platform at the server and for coupling to the payment gateway when the application software is loaded to a processor of the mobile device for interaction by the user with the recommendation-providing social media platform via a user interface of the mobile device. The payment gateway detects settlement of a transaction of a user at a merchant having a merchant location in a predefined area. The payment gateway also has historic transaction data of the user stored thereat. The mobile communication device provides a present location of the wireless communication device to the recommendation-providing social media platform so that the recommendation-providing social media platform can automatically check in the user to the merchant location and the predefined area on the recommendation-providing social media platform in response to settling the transaction at the merchant and receives information on other merchant locations within the predefined area from the server hosting the recommendation-providing social media platform. The payment gateway identifies ones of the other merchants at the other merchant locations for recommending to the user in response to receiving the information on other merchant locations within the predefined area from the server hosting the recommendation-providing social media platform and in response to the historic transaction data of the user, the payment gateway providing merchant information for the identified ones of the other merchants in the predefined area to the mobile communication device. The mobile communication device then presents the user through the application software the merchant information for the identified ones of the other merchants in the predefined area, the merchant information for the identified ones of the other merchants in the predefined area including a merchant location corresponding to each of the identified ones of the other merchants in the predefined area.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to illustrate various embodiments and to explain various principles and advantages in accordance with a present invention, by way of non-limiting example only, wherein:

FIG. 1 illustrates a block diagram of a system for providing location-based user-personalized recommendations for goods, services and activities in accordance with a present embodiment;

FIG. 2 illustrates a block diagram of a mobile communication device for operation in the system of FIG. 1 in accordance with the present embodiment;

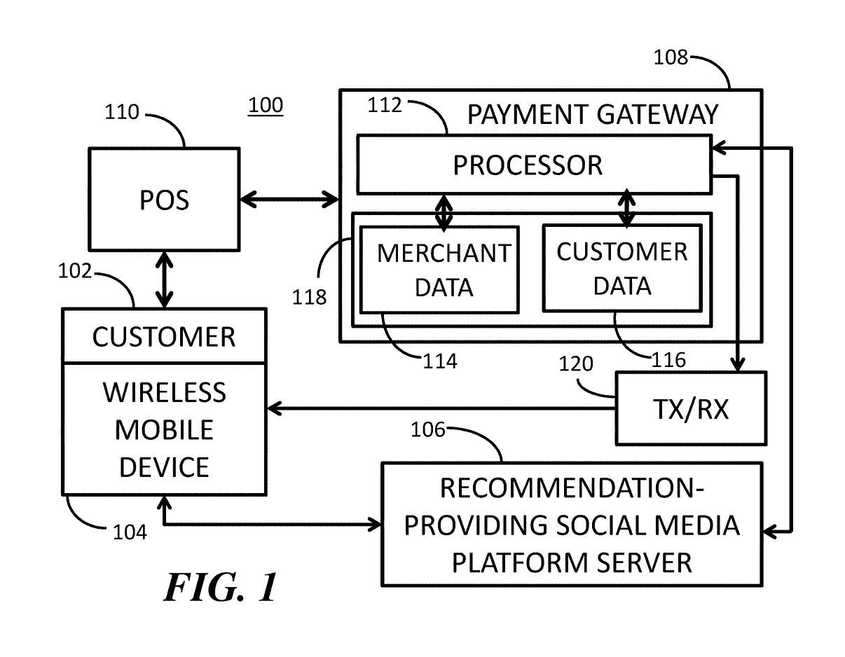

And FIG. 3 illustrates a flow chart of operation of the system of FIG. 1 in accordance with the present embodiment.

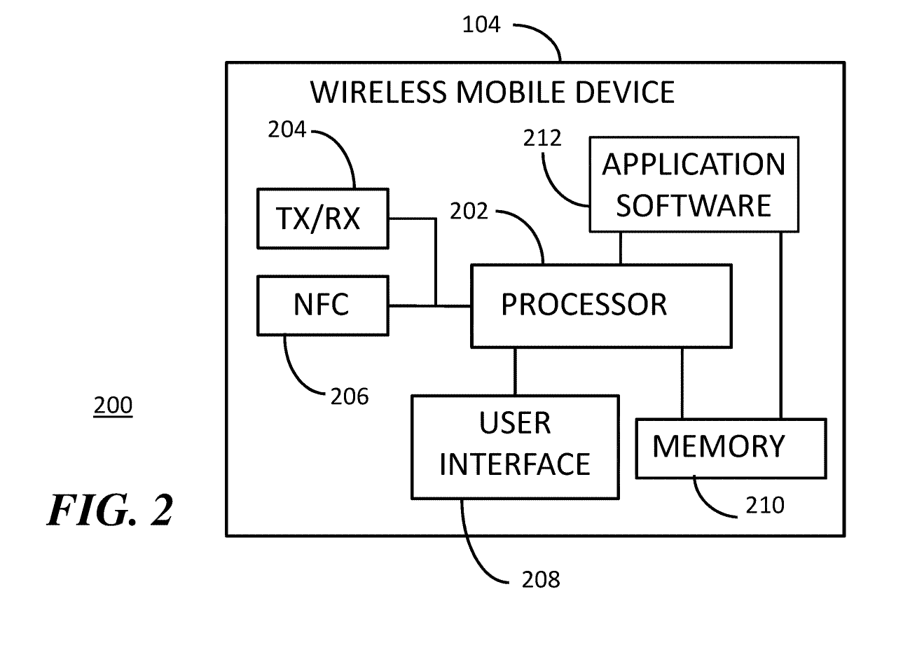

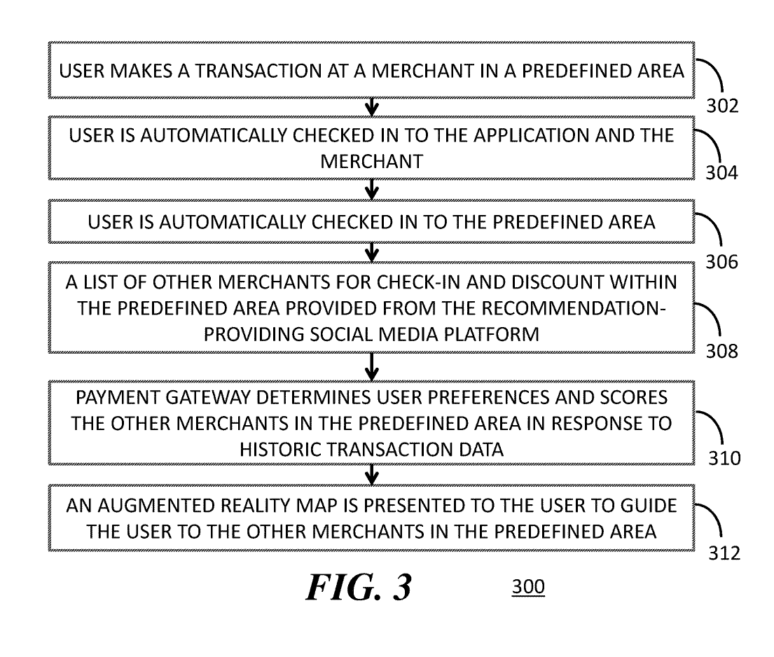

Skilled artisans will appreciate that elements in the figures are illustrated for simplicity and clarity and have not necessarily been depicted to scale. For example, the size of some of the blocks in the block diagrams of FIGS. 1 and 2 may not be accurate in respect to other blocks and are shown in this manner to improve understanding of the elements of the system and devices in accordance with the present embodiment.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description. It is the intent of this invention to present a system and method for providing location-based user-personalized recommendations for goods, services and activities. In order to better understand the description of the present embodiment, the terms “recommendation-providing social media platform”. “application software” and “check-in” as used in the present application are defined.

A “recommendation-providing social media platform” in accordance with the present embodiment is a program running on a server which is internet accessible by registered users to provide recommendations for goods and services as well as goods and/or services related incentives such as discounts or loyalty programs. The recommendations can be provided in accordance with various criteria such as the user's preferences or the user's present location.

“Application software” is software loaded on a wired or wireless mobile device such as a smartphone, a laptop, a pad device (such as an iPad®) or a notebook. In some instances, such as for many smartphones, the “application software” can be referred to as an ‘app’. In accordance with the present embodiment, the “application software” allows the user to communicate through the wired or wireless device with the recommendation-providing social media platform for interaction therewith, such as providing location information to obtain geographically relevant goods and services recommendations or to provide user preferences.

“Check-in” is defined in accordance with the present embodiment to mean providing present location information, such as geographic coordinates, to the recommendation-providing social media platform for a user of the recommendation-providing social media platform so that the recommendation-providing social media platform can provide the user with location-relevant recommendations for goods and services and provide incentives for such nearby providers of goods and services.

Referring to FIG. 1, a block diagram 100 illustrates a system for providing location-based user-personalized recommendations for goods, services and activities in accordance with a present embodiment. The system includes a customer 102 having a wireless mobile device 104. The system also includes a server 106 which hosts a recommendation-providing social media platform such as Foursquare™ which wirelessly couples to the wireless mobile device 104 via application software as discussed in more detail below. Finally, the system includes a payment gateway 108 which couples to a merchant's point-of-sale (POS) device 110 for settling customer transactions in a manner known to those skilled in the art.

In order to settle customer transactions, the payment gateway 108 includes a processor 112 which stores merchant data 114 and customer data 116 in a data base 118. In accordance with the present embodiment, the payment gateway is also coupleable to a transceiver 120 for communicating with the wireless mobile device 104 and coupleable to the server 106 for transferring information to and receiving information from the recommendation-providing social media platform.

Referring to FIG. 2, the wireless mobile device 104 includes a processor 202, a transceiver 204, a near field communication (NFC) transceiver 206, a user interface 208 and a memory 210. The transceiver 204 is coupled to the processor 202 for communicating with the payment gateway 108 via the transceiver 120 and for communicating with the server 106 hosting the recommendation-providing social media platform. The memory 210 stores application software 212 which a user can load to the processor 202 for coupling to the recommendation-providing social media platform at the server 106 allowing interaction by the user with the recommendation-providing social media platform via the user interface 208. The user interface 208 includes a user input device for receiving user inputs and a user output device for presenting information to the user including visually displayed information.

Referring to FIG. 3, a flowchart 300 of the operation of the system 100 in accordance with the present embodiment is shown. As mentioned before, the problem associated with check-ins via social media platforms like Foursquare™ is that these applications do not have past purchase history associated with the user (e.g., customer 102). The historical data of the user can be used by merchants to give targeted offers like coupons and other location based offers. The solution proposed in accordance with the present embodiment solves this problem by automatically checking in the user based on the card transaction at the merchant's POS 110 and determining the location of user based on the location of the merchant.

First, the customer 102 makes a transaction 302 at a merchant by settling the transaction at the POS 110. The memory 210 is coupled to the processor 202 and stores the application software 212 for coupling to the recommendation-providing social media platform at the server 106 when the application software 212 is loaded to the processor 202 for interaction by the user with the recommendation-providing social media platform via the user interface 208. In accordance with one aspect of the present embodiment, the customer 102 has the application software 212 running on the processor 202 when the card transaction 302 occurs at the POS 110. In accordance with another aspect of the present embodiment, the customer 102 may have a flag set to automatically load the application software 212 onto the processor 202 in response to the card transaction 302 occurring at the POS 110.

Whichever way the application software 212 has become loaded to the processor, in response to the user settling a transaction at the merchant POS 110, the processor 202 automatically checks the user in 304 to the recommendation-providing social media platform 106 via the application software 212 with the merchant geographic coordinates as the current location. This can occur by NFC communication between the POS 110 and the active mobile handset 104 to settle the transaction also notifying the processor 202 of the geographic coordinates of the merchant to provide to the recommendation-providing social media platform 106 via the application software 212 to check the user in 304 to the recommendation-providing social media platform 106 at the merchant's location. Alternatively, if there is no direct communication link between the POS and the wireless mobile device 104 (e.g., where the credit/debit card is swiped at the POS 110), the payment gateway 108 will communicate with the mobile device 104 via the transceiver 120 (FIG. 1) to instruct the processor 202 to automatically check the user in to 304 the merchant location by providing the processor 202 the geographic coordinates of the merchant to provide to the recommendation-providing social media platform 106 via the application software 212.

The merchant is located in a predefined area. The predefined area includes a bounded area where goods, services and/or activities are provided by multiple merchants, such as an airport, a mall or a shopping centre. In addition to automatically checking the user in to 304 the recommendation-providing social media platform 106 at the merchant location via the application software 212, in accordance with the present embodiment as described above, the user is automatically checked in to 306 the predefined area by the recommendation-providing social media platform 106 (e.g., the recommendation-providing social media platform 106 recognizing that the merchant is located within the predefined area and then the platform checking the user in to the predefined area on the recommendation-providing social media platform 106). A list of other merchants within the predefined area are provided 308 by the recommendation-providing social media platform through the application software 212 to the payment gateway 108. This list includes merchants within the predefined area who are registered with the recommendation-providing social media platform and who provide discounts, cashbacks or other incentive offers, and the information provided includes merchant locations and merchant discount information of the registered merchants in the predefined area.

The payment gateway 108 has historic transaction data 116 of the user stored thereat. The payment gateway 108 identifies 310 ones of the other merchants within the predefined area for recommending to the user in response to receiving the information on other merchant locations within the predefined area and in response to the historic transaction data of the user 116 by scoring the other merchants. The payment gateway 108 scores the identified merchants in response to user preferences determined from the historic transaction data such as prior purchases with the merchants and repeat purchases in similar stores elsewhere.

The payment gateway 108 then provides merchant information for the identified ones of the other merchants in the predefined area to the mobile device 102 along with the scoring for those merchants. The scoring may be indicated by the order in which the merchants are listed. The mobile device 102 then presents 312 the user through the recommendation-providing social media platform via the application software 212 and a display of the user interface 208 the merchant information for the identified ones of the other merchants in the predefined area, the merchant information for the identified ones of the other merchants in the predefined area including a merchant location corresponding to each of the identified ones of the other merchants in the predefined area. The scoring by the payment gateway 108 may be indicated by sorting the merchants in a particular order to indicate the higher scores first and lower scores later. In accordance with the application software 212, user preference flags set within the application software may further adjust the order of the merchants in the user presentation.

In this manner, while typically all the location based discounts and offers are pushed through the application software 212, in accordance with the present embodiment, only those merchant location based offers are pushed through the application software 212 to the user which score higher with respect to repeat purchases in similar stores elsewhere. The benefit for the user is that the user is automatically checked-in 304 so that the user becomes eligible for discounts which are based on a number of check-ins with a merchant and the user obtains location based offers based on his past purchase history. The application software 212 may then present 312 a display of the predefined area with the other merchant locations identified in order to guide the user to these merchant locations. The presentation may be in the form of an augmented reality map of the predefined area.

Thus, it can be seen that the present embodiment can provide a system and method for automatically checking the user in to a merchant so that the user becomes applicable for discounts which are based on a number of check-ins with that merchant and obtains location based offers for a predefined area around the merchant in response to automatically checking the user into the predefined area and pushing merchant discount information including the location based offers in a manner indicative of personal preferences of the user based on his past purchase history. While exemplary embodiments have been presented in the foregoing detailed description of the invention, it should be appreciated that a vast number of variations exist.

It should further be appreciated that the exemplary embodiments are only examples, and are not intended to limit the scope, applicability, operation, or configuration of the invention in any way. Rather, the foregoing detailed description will provide those skilled in the art with a convenient road map for implementing an exemplary embodiment of the invention, it being understood that various changes may be made in the function and arrangement of elements and method of operation described in an exemplary embodiment without departing from the scope of the invention as set forth in the appended claims.

What is claimed is:

1. A method for providing location-based user-personalized recommendations for goods, services and activities to a user of a mobile communication device having application software capable of accessing a recommendation-providing social media platform loaded thereon, the method comprising:
the user settling a transaction at a merchant having a merchant location;
automatically checking-in the user to the merchant location on the recommendation-providing social media platform in response to settling the transaction at the merchant;
automatically checking-in the user to a predefined area which includes the merchant location on the recommendation-providing social media platform; and
identifying ones of other merchants at other merchant locations within the predefined area for recommending to the user in response to user historic transaction data.

2. The method in accordance with claim 1 further comprising presenting the user through the application software with merchant information for the identified ones of the other merchants in the predefined area, the merchant information for the identified ones of the other merchants in the predefined area including a merchant location corresponding to each of the identified ones of the other merchants in the predefined area.

3. The method in accordance with claim 1 further comprising launching the application software on the mobile communication device before the settling transaction step.

4. The method in accordance with claim 1 wherein the step of automatically checking-in comprises:
automatically launching the application software on the mobile communication device of the user in response to settling the transaction at the merchant; and
thereafter checking-in to the merchant location on the recommendation-providing social media platform.

5. The method in accordance with claim 2 wherein the step of automatically checking-in to the predefined area includes obtaining the other merchant locations and merchant discount information from the other merchants; and wherein the step of presenting the user with merchant information for the identified ones of the other merchants in the predefined area comprises presenting the user through the application software with merchant information for the identified ones of the other merchants in the predefined area, the merchant information for the identified ones of the other merchants in the predefined area further including the merchant discount information.

6. The method in accordance with claim 1 wherein the step of settling the transaction comprises the user settling the transaction at the merchant by utilizing payment card data, such as payment card data stored on a credit card, a debit card or a prepaid card.

7. The method in accordance with claim 6 wherein the step of the user settling the transaction at the merchant by utilizing the payment card data comprises the step of a user's payment card being swiped at a point-of-sale (POS) device.

8. The method in accordance with claim 6 wherein the step of the user settling the transaction at the merchant by utilizing the payment card data comprises the step of the wireless communication device of the user communicating the payment card data to a POS device via near field communication (NFC).

9. The method in accordance with claim 1 further comprising before the step of identifying the ones of the other merchants at the other merchant locations the step of obtaining the user historic data by retrieving a portion of historic transaction data from a payment gateway having historic transaction data stored thereat.

10. The method in accordance with claim 9 wherein the step of obtaining the user historic data comprises:
forwarding information including the other merchants at the other merchant locations in the predefined area to the payment gateway;
the payment gateway identifying the portion of the historic transaction data stored thereat in response to the other merchants and the other merchant locations in the predefined area;
the payment gateway identifying the ones of the other merchants at the other merchant locations for recommending to the user in response to the portion of the user historic transaction data;
the payment gateway scoring the identified ones of the other merchants at the other merchant locations for recommending to the user in response to user preferences determined from the historic transaction data; and
the payment gateway forwarding the identified ones of the merchants at the other merchant locations along with an indication of their scoring to the wireless communication device of the user for recommending to the user through the application software.

11. The method in accordance with claim 10 wherein the step of the payment gateway forwarding the identified ones of the merchants at the other merchant locations along with an indication of their scoring to the wireless communication device of the user comprises forwarding the identified ones of the merchants at the other merchant locations in an order which provides the indication of their scoring.

12. The method in accordance with claim 2 wherein the presenting step comprises presenting a visual display on the mobile communication device of the user, the visual display comprising an augmented reality map of at least a portion of the predefined area including one or more merchant locations corresponding to each of the identified ones of the merchants in the predefined area.

13. The method in accordance with claim 1 wherein the identifying step further comprises identifying the ones of the other merchants at the other merchant locations for recommending to the user in response to user information previously provided to the recommendation-providing social media platform.

14. The method in accordance with claim 13 wherein the user information previously provided to the recommendation-providing social media platform includes user-indicated preferences.

15. A method in a server which provides a payment gateway for settling transactions, the server comprising storage means for storing historic transactions of a user, the method comprising:
receiving transaction data for settling a transaction between the user and a merchant having a merchant location within a predefined area;
identifying ones of other merchants at other merchant locations within the same predefined area for recommending to the user in response to user preferences determined from the historic transaction data of the user; and
providing information on the identified ones of the other merchants within the predefined area to a mobile communication device of the user for presentation to the user through application software on the mobile communication device.

16. The method in accordance with claim 15 wherein the step of identifying the ones of the other merchants at the other merchant locations within the predefined area comprises identifying the ones of the other merchants at the other merchant locations within the predefined area for recommending to the user in response to receiving information on merchants in the predefined area identified by a recommendation-providing social media platform to which the user is checked-in.

17. The method in accordance with claim 15 further comprising generating scoring information for the ones of the other merchants at the other merchant locations within the predefined area for recommending to the user in response to the user preferences determined from the historic transaction data of the user, and wherein the step of providing the information on the identified ones of the other merchants within the predefined area to the mobile communication device of the user includes also providing the scoring information for the ones of the other merchants at the other merchant locations within the predefined area.

18. A wireless communication device comprising:
a processor;
a transceiver coupled to the processor for communicating with a payment gateway and for communicating with a server hosting a recommendation-providing social media platform including merchant information for a plurality of merchants within a predefined area;
a user interface coupled to the processor and including a user input device for receiving user inputs and a user output device for presenting information to a user including visually displayed information; and
a memory coupled to the processor and storing application software for coupling to the recommendation-providing social media platform at the server and the payment gateway when the application software is loaded to the processor for interaction by the user with the recommendation-providing social media platform via the user interface and for requesting and receiving information from the payment gateway,
wherein, in response to the user settling a transaction at a merchant having a merchant location within a predefined area, the processor provides a present location of the wireless communication device to the recommendation-providing social media platform so that the recommendation-providing social media platform can automatically check the user in to the merchant and automatically check the user in to the predefined area on the recommendation-providing social media platform, and wherein the user interface presents the user through the application software merchant information for identified ones of other merchants in the predefined area, the identified ones of the other merchants in the predefined area identified by information forwarded from the payment gateway identifying the identified ones of the other merchants in the predefined area in response to historic transaction data of the user.

19. A system for providing location-based user-personalized recommendations for goods, services and activities, the system comprising:
a payment gateway for detecting settlement of a transaction of a user at a merchant having a merchant location in a predefined area, the payment gateway having historic transaction data of the user stored thereat;
a server hosting a recommendation-providing social media platform; and
a mobile communication device of the user having application software stored thereon for coupling to the recommendation-providing social media platform at the server and for coupling to the payment gateway when the application software is loaded to a processor of the mobile device for interaction by the user with the recommendation-providing social media platform via a user interface of the mobile device,
wherein the mobile communication device provides a present location of the wireless communication device to the recommendation-providing social media platform so that the recommendation-providing social media platform can automatically check in the user to the merchant location and the predefined area on the recommendation-providing social media platform in response to settling the transaction at the merchant and receives information on other merchant locations within the predefined area from the server hosting the recommendation-providing social media platform, and
wherein the payment gateway identifies ones of the other merchants at the other merchant locations for recommending to the user in response to receiving the information on other merchant locations within the predefined area from the server hosting the recommendation-providing social media platform and in response to the historic transaction data of the user, the payment gateway providing merchant information for the identified ones of the other merchants in the predefined area to the mobile communication device, and
wherein the mobile communication device presents the user through the application software the merchant information for the identified ones of the other merchants in the predefined area, the merchant information for the identified ones of the other merchants in the predefined area including a merchant location corresponding to each of the identified ones of the other merchants in the predefined area.

20. The system in accordance with claim 19 wherein the predefined area comprises a bounded area wherein goods, services and/or activities are provided by multiple merchants.

21. The system in accordance with claim 20 wherein the predefined area comprises a bounded area selected from an airport, a mall and a shopping centre.

22. The system in accordance with claim 19 wherein the payment gateway further generates scoring information for the ones of the other merchants at the other merchant locations within the predefined area for recommending to the user in response to the user preferences determined from the historic transaction data of the user and provides the scoring information along with the merchant information to the mobile communication device, and wherein the mobile communication device presents to the user through the application software an indication of the scoring information for the ones of the other merchants at the other merchant locations within the predefined area along with the merchant information.
